(19) United States
(12) Patent Application Publication
(10) Pub. No.: US 2011/0129660 A1
(43) Pub. Date: Jun. 2, 2011

(54) Water-Repellent Light Weight Cellular Concrete Panel, Method of Producing The Aforesaid, And Water-Based Organopolysiloxane Emulsion

(76) Inventors: Kenji Jimpachi, Ichihara-shi (JP); Masakado Kennoki, Ichihara-shi (JP); Tsutomu Naganawa, Ichihara-shi (JP)

(21) Appl. No.: 12/921,716

(22) PCT Filed: Mar. 11, 2009
(86) PCT No.: PCT/JP2009/055540

§ 371 Date: Dec. 2, 2010

(30) Foreign Application Priority Data
Mar. 11, 2008 (JP) 2008-061679

(51) Int. Cl. B32B 5/18; B05D 3/02; B05D 1/02; B05D 1/28; C09D 183/04

(52) U.S. Cl. 428/319.3; 427/387; 524/588

(57) ABSTRACT

A water-repellent lightweight cellular concrete panel having on its surface a water-repellent treatment layer provided by a water-based emulsion of a non-film-forming amino-modified organopolysiloxane. A water-based emulsion of a non-film-forming amino-modified organopolysiloxane is applied, by a spray method or a roller coating method, on the surface of lightweight cellular concrete panel and drying is carried out. An O/W water-based emulsion of a non-film-forming amino-modified organopolysiloxane that has an amine equivalent weight of 500 to 100,000 gram/mol and a viscosity at 25° C. of 50 to 1,000,000 mPa·s.

### TECHNICAL FIELD

The present invention relates to a water-repellent lightweight cellular concrete panel—and particularly a water-repellent lightweight cellular concrete panel for short-term storage—that has on its surface a water-repellent treatment layer that has been provided by a water-based emulsion of a non-film-forming amino-modified organopolysiloxane, to a method of producing the aforesaid, and to a water-based emulsion of non-film-forming amino-modified organopolysiloxane wherein this emulsion is intended to provide a water-repellent treatment of the surface of lightweight cellular concrete panels.

### BACKGROUND ART

Lightweight cellular concrete panels have to date been widely used as a construction material, for example, for outside walls, partitions, floors, roofs, and so forth, because these panels offer the advantages of, inter alia, light weight, fire resistance, thermal insulation, and installability. Particulate siliceous materials and calcareous materials are the base ingredients of these lightweight cellular concrete panels, and these panels are produced by causing cells or air bubbles to be present therein, thereafter semi-curing, and further curing with steam at high temperatures and high pressures.

A lightweight cellular concrete panel contains about 40 weight % water immediately after its production, but the moisture fraction reaches about 10 weight % as a consequence of drying during the time interval taken up by storage, shipping, and installation.

Due to their large size as well as the large numbers involved, the storage of lightweight cellular concrete panels indoors is substantially not a possibility and they are generally stored outdoors. In order to protect the lightweight cellular concrete panels from rain and snow, one might contemplate the tactic of covering the panels with vinyl sheeting. However, the execution of this tactic at such a large site as a lightweight cellular concrete panel factory requires a great deal of time and labor for covering and uncovering the stacked lightweight cellular concrete panels; this tactic also inhibits panel drying. Moreover, when one considers the total cost for the vinyl sheeting, including the cost of acquisition, storage, and management, this tactic can certainly not be regarded as very practical.

However, when lightweight cellular concrete panels stored outside without being covered by vinyl sheeting are exposed to rain or snow, water is then absorbed across the outer surface, which not only slows down drying, but also eventually causes a white lightweight cellular concrete panel to become discolored to grey or reddish brown. The result is a deterioration in the appearance and quality and an increase in the weight of the lightweight cellular concrete panel.

Moreover, not only is the outer surface of the lightweight cellular concrete panel discolored by water absorption, but during rainfall the dust floating in the atmosphere becomes attached to the surface of the lightweight cellular concrete panel and during the drying process forms contamination and staining and remains on the outer surface of the lightweight cellular concrete panel, causing a decline in the appearance and quality.

As a consequence, in order to prevent the absorption of water across the outer surface of a lightweight cellular concrete panel that is stored outdoors, a method of producing water-repellent lightweight cellular concrete panel has been introduced in which, considered briefly, the lightweight cellular concrete panel is provided with water repellency by mixing, during production of the lightweight cellular concrete panel, a silicone-type water-repellent substance into the starting slurry mixture of a foaming agent (e.g., aluminum metal), water, and the base ingredients of siliceous material and calcareous material (see Patent Reference 1, Patent Reference 2).

Once a lightweight cellular concrete panel is installed in the interior of a structure it is no longer exposed to rain and snow, while a waterproof paint is applied soon after installation on an outer wall or roof of a structure. As a consequence, in these cases the maintenance of a short-term water repellency up to installation of the lightweight cellular concrete panel is acceptable rather than employing a permanent water-repellent behavior. This has resulted in the introduction of lightweight cellular concrete panels that on a short-term basis do not undergo water absorption-induced discoloration or weight gain, by virtue of having been made water repellent by coating the outer surface of the lightweight cellular concrete panel with a small amount of waterborne emulsion-type water-repellent agent having alkylalkoxysilane as its base component or with a small amount of a waterborne emulsion-type water-repellent agent having alkylalkoxysilane and siloxane as its base components (see Patent Reference 3, Patent Reference 4).

Since the interior region, where water repellency is not necessary, is made water repellent in the production method in which water repellency is provided by mixing a silicone-type water-repellent substance into the starting slurry, one problem with this method is that the water repellency of the lightweight cellular concrete panel surface is inadequate unless large amounts of the water-repellent substance are incorporated. Another problem is that the resulting lightweight cellular concrete panel is difficult to bond with mortar-based repair materials when the attempt is made to repair chipped or damaged regions with a mortar-based repair material.

With regard, on the other hand, to lightweight cellular concrete panel that has been provided with a short-term water repellency by coating with a waterborne emulsion-type water-repellent agent having alkylalkoxysilane as its base component or a waterborne emulsion-type water-repellent agent having alkylalkoxysilane and siloxane as its base components, one problem has been poor bonding by the mortar or acrylic-type waterborne sealant when the attempt is made to seal the joints between/among installed lightweight cellular concrete panels using mortar or an acrylic-type waterborne sealant. Another problem has been poor paint adhesion when the surface of the installed lightweight cellular concrete panel is coated with a water-based synthetic resin paint for the purpose of forming a waterproof layer thereon.

To solve these problems, one can consider the method provided in Patent Reference 5, in which a hydrophilic surfactant is applied to the surface coated with the waterborne emulsion-type water-repellent agent having alkylalkoxysilane as its base component or the waterborne emulsion-type water-repellent agent having alkylalkoxysilane and siloxane as its base components. This method, however, is expensive and also increases the number of process steps.

Methods can also be considered in which application of the waterborne emulsion-type water-repellent agent having alkylalkoxysilane as its base component or waterborne emulsion-type water-repellent agent having alkylalkoxysilane and siloxane as its base components is replaced by the following: the application of an emulsion polymerization latex from cyclic diorganopolysiloxane and functional group-containing trialkylsilane, as taught in the method provided in Patent Reference 6; the application of an emulsion of aminoalkyltrialkoxysilane and α,ω-dihydroxypolydialkylsiloxane, as taught in the method provided in Patent Reference 7; and the application of an emulsion that contains

(A) a component selected from (A1) C₁ to C₂₀-hydrocarbyl-C₁ to C₆-alkoxysilane and (A2) branched organopolysiloxane that contains C₁ to C₆ alkoxy groups,
(B) a component selected from (B1) C₁ to C₆ alkoxysilane that contains aminoalkyl groups and (B2) a branched organosiloxane that contains aminoalkyl groups, and
(C) an emulsifying agent,
as taught in the method provided in Patent Reference 8.

However, each of the preceding employs an emulsion of a film-forming organopolysiloxane that forms a cured coating or a solidified coating as the water fraction evaporates. In the case of the spray coating, i.e., spray equipment, that is generally employed, this causes the problem of nozzle clogging and conduit clogging due to film formation in the nozzle and conduits of the sprayer. In the case of roller application, a cured coating or solidified coating forms on the roller surface during continuous coating operations, which renders the roller surface water repellent and thereby prevents uptake of the emulsion and makes it impossible to continue with the coating operation.
[Patent Reference 1] JP 55-042272 A
[Patent Reference 2] JP 58-049507 B
[Patent Reference 3] JP 2000-072567 A
[Patent Reference 4] JP 2005-000742 A
[Patent Reference 5] JP 2002-317524 A
[Patent Reference 6] JP 57-095882 A
[Patent Reference 7] U.S. Pat. No. 5,196,054
[Patent Reference 8] JP 11-241025 A

### SUMMARY OF INVENTION

### Technical Problems to be Solved

An object of the present invention is to provide a water-repellent lightweight cellular concrete panel that maintains an excellent water repellency for at least two to three months from immediately after its production, that does not impair evaporation of the water that is present in the lightweight cellular concrete panel immediately after the panel's production, and that does not impair adhesion of an acrylic-type waterborne sealant, a mortar-based repair agent, or a water-based synthetic resin paint to the water-repellent surface. A further object of the present invention is to provide a method of producing this water-repellent lightweight cellular concrete panel.

An additional object of the present invention is to provide a water-repellent lightweight cellular concrete panel for short-term storage, that maintains an excellent short-term water repellency for at least two to three months from immediately after its production, that does not impair evaporation of the water that is present in the lightweight cellular concrete panel immediately after the panel's production, and that does not impair adhesion of an acrylic-type waterborne sealant, a mortar-based repair agent, or a water-based synthetic resin paint to the water-repellent surface. A further object of the present invention is to provide a method of producing this water-repellent lightweight cellular concrete panel for short-term storage.

Another object of the present invention is to provide a water-based organopolysiloxane emulsion that does not clog the nozzle or conduits of the spray equipment during spray application, that does not form a waterproof film on the roller surface during continuous roller application, that can impart water repellency to the outer surface of lightweight cellular concrete panels, and that, when applied to the surface of a lightweight cellular concrete panel immediately after the panel's production, maintains an excellent short-term water repellency for at least two to three months, does not impair evaporation of the water present in the lightweight cellular concrete panel immediately after the panel's production, and does not impair adhesion of an acrylic-type waterborne sealant, a mortar-based repair agent, or a water-based synthetic resin paint to the water-repellent surface.

### Solution to Problems

The aforementioned objects are achieved by

“[1] A water-repellent lightweight cellular concrete panel, comprising a lightweight cellular concrete panel having on its surface a water-repellent treatment layer provided by a water-based emulsion of a non-film-forming amino-modified organopolysiloxane.
[2] A method of producing a lightweight cellular concrete panel having a water-repellent treatment layer on the surface, comprising

applying, by a spray method or a roller coating method, a water-based emulsion of a non-film-forming amino-modified organopolysiloxane to the surface of a lightweight cellular concrete panel; and

drying the applied emulsion.”

The aforementioned objects are also achieved by

“[3] A water-repellent lightweight cellular concrete panel for short-term storage, comprising a water-containing lightweight cellular concrete panel that has siliceous material and calcareous material as its base ingredients and that has been produced by causing cells to be present therein, thereafter semi-curing, and further curing with steam at high temperature and high pressure, and a water-repellent treatment layer formed on the surface of the water-containing lightweight cellular concrete panel by the attachment to this surface, at 0.6 to 12.0 g/m² as effective component, of a water-based emulsion of a non-film-forming amino-modified organopolysiloxane.
[4] A method of producing a water-repellent lightweight cellular concrete panel for short-term storage, that has a water-repellent treatment layer on its surface, said method being comprising:

applying, by a spray method or a roller coating method, a water-based emulsion of a non-film-forming amino-modified organopolysiloxane at 0.6 to 12.0 g/m² as effective component to the surface of a water-containing lightweight cellular concrete panel that has siliceous material and calcareous material as its base ingredients and that has been produced by causing cells to be present therein, thereafter semi-curing, and further curing with steam at high temperature and high pressure; and

drying the applied emulsion.”

The aforementioned objects are also achieved by

“[5] A water-based organopolysiloxane emulsion for effecting a water-repellent treatment on the surface of a lightweight cellular concrete panel, characterized in that the emulsion is an O/W emulsion, the average particle size of the emulsion particles is 10 to 1000 nm, and the organopolysiloxane is a non-film-forming amino-modified organopolysiloxane and has an amine equivalent weight of 500 to 100,000 gram/mol and a viscosity at 25° C. of 50 to 1,000,000 mPa·s.
[5-1] The water-based organopolysiloxane emulsion according to [5] wherein the average particle size of the emulsion particles is the volume-average particle size in the volumetric particle size distribution measured on the emulsion particles by a laser scattering-type submicron particle analyzer.
[6] The water-based organopolysiloxane emulsion according to [5] for effecting a water-repellent treatment on the surface of a lightweight cellular concrete panel, characterized in that the non-film-forming amino-modified organopolysiloxane is a non-film-forming amino-modified diorganopolysiloxane.
[7] The water-based organopolysiloxane emulsion according to [6] for effecting a water-repellent treatment on the surface of a lightweight cellular concrete panel, characterized in that the non-film-forming amino-modified diorganopolysiloxane is a dimethylpolysiloxane that has only methyl group bonded to the terminal silicon atoms or that has methyl and hydroxyl groups bonded to the terminal silicon atoms and that has a portion of its methyl groups replaced by aminoalkyl or N-(aminoalkyl)aminoalkyl group.
[7-1] The water-based organopolysiloxane emulsion according to [7] for effecting a water-repellent treatment on the surface of a lightweight cellular concrete panel, characterized in that the aminoalkyl group is aminopropyl group and the N-(aminoalkyl)aminoalkyl group is N-(aminoethyl)aminopropyl group.
[8] The water-based organopolysiloxane emulsion according to [5] for effecting a water-repellent treatment on the surface of a lightweight cellular concrete panel, characterized in that all or a portion of the amino groups in the non-film-forming amino-modified organopolysiloxane are neutralized with an organic acid or a mineral acid.
[8-1] The water-based organopolysiloxane emulsion according to [6], [7], or [7-1] for effecting a water-repellent treatment on the surface of a lightweight cellular concrete panel, characterized in that all or a portion of the amino groups in the non-film-forming amino-modified diorganopolysiloxane are neutralized with an organic acid or a mineral acid.”

### Advantageous Effects of Invention

The water-repellent lightweight cellular concrete panel of the present invention maintains an excellent water repellency for at least two to three months from immediately after its production, does not impair evaporation of the water that is present in the lightweight cellular concrete panel immediately after the panel's production, and does not impair adhesion of an acrylic-type waterborne sealant, a mortar-based repair agent, or a water-based synthetic resin paint to the water-repellent surface.

The inventive method of producing lightweight cellular concrete panel avoids clogging of the nozzle and conduits of the spray equipment during spray application on the surface of lightweight cellular concrete panel and avoids the formation of a waterproof film on the roller surface during continuous roller application. This method can produce a water-repellent lightweight cellular concrete panel that maintains an excellent water repellency for at least two to three months from immediately after the panel's production, that does not impair evaporation of the water present in the lightweight cellular concrete panel immediately after the panel's production, and that does not impair adhesion of an acrylic-type waterborne sealant, a mortar-based repair agent, or a water-based synthetic resin paint to the water-repellent surface.

The inventive water-repellent lightweight cellular concrete panel for short-term storage maintains an excellent short-term water repellency for at least two to three months from immediately after its production, does not impair evaporation of the water that is present in the lightweight cellular concrete panel immediately after the panel's production, and does not impair adhesion of an acrylic-type waterborne sealant, a mortar-based repair agent, or a water-based synthetic resin paint to the water-repellent surface.

The inventive method of producing lightweight cellular concrete panel for short-term storage avoids clogging of the nozzle and conduits of the spray equipment during spray application on the surface of lightweight cellular concrete panel and avoids the formation of a waterproof film on the roller surface during continuous roller application. This method can produce a water-repellent lightweight cellular concrete panel for short-term storage that maintains an excellent water repellency for at least two to three months from immediately after the panel's production, that does not impair evaporation of the water present in the lightweight cellular concrete panel immediately after the panel's production, and that does not impair adhesion of an acrylic-type waterborne sealant, a mortar-based repair agent, or a water-based synthetic resin paint to the water-repellent surface.

The inventive water-based organopolysiloxane emulsion for effecting a water-repellent treatment on the surface of a lightweight cellular concrete panel and particularly lightweight cellular concrete panel for short-term storage, does not clog the nozzle or conduits of the spray equipment during spray application, does not form a waterproof film on the roller surface during continuous roller application, can impart water repellency to the outer surface of a lightweight cellular concrete panels, and, when applied to the surface of a lightweight cellular concrete panel immediately after the panel's production, maintains an excellent water repellency for at least two to three months, does not impair evaporation of the water that is present in the lightweight cellular concrete panel immediately after the panel's production, and does not impair adhesion of an acrylic-type waterborne sealant, a mortar-based repair agent, or a water-based synthetic resin paint to the water-repellent surface.

In addition, the aforementioned water-based organopolysiloxane emulsion of the present invention exhibits an excellent storage stability and an excellent permeability into lightweight cellular concrete panels.

### DESCRIPTION OF EMBODIMENTS

The water-repellent lightweight cellular concrete panel of the present invention characteristically has on its surface a water-repellent treatment layer provided from a water-based emulsion of a non-film-forming amino-modified organopolysiloxane.

With regard to the lightweight cellular concrete in the lightweight cellular concrete panel that is subjected in the present invention to water-repellent treatment with the non-film-forming amino-modified organopolysiloxane, this lightweight cellular concrete is not limited to the lightweight cellular concrete in the range specified by JIS and refers to a broad range of lightweight cellular concretes.

The lightweight cellular concrete is generally produced by admixing gypsum, a foaming agent, and water into the base ingredients comprising a siliceous ingredient (e.g., silica stone and so forth), a calcareous ingredient (e.g., calcined lime, cement, and so forth), and so forth; pouring the resulting slurry into a mold form; foaming and semi-curing; and thereafter bringing about a complete cure by autoclave curing.

The lightweight cellular concrete panel is typically produced by the following method. Gypsum, foaming agent, and water are added to the base ingredients comprising a siliceous ingredient (e.g., silica stone and so forth), a calcareous ingredient (e.g., calcined lime, cement, and so forth), and so forth, with mixing in a mixer. The resulting mixed slurry is poured into a mold form in which reinforcing bars have previously been disposed. The slurry is cured in the form while also foaming, resulting in the formation of a semi-cured article. This semi-cured article is released from the form and is cut to a prescribed shape with piano wire. The semi-cured article of prescribed shape is then placed in an autoclave tank and is subjected to curing at high temperatures and high pressures. Curing of the semi-cured article is brought to completion by this high-temperature, high-pressure cure to produce the lightweight cellular concrete panel.

The siliceous ingredient used here is typically silica stone comprising quartz having an average single crystal grain size of 10 μm to 100 μm, and two or three types of silica stone having different average single crystal grain size ranges may be used.

Silica sand may be used in place of the silica stone, and, for example, noncrystalline silica, e.g., diatomaceous earth, fly ash, blast furnace slag, and so forth, may also be mixed to some extent into the silica stone.

The calcareous ingredient is generally calcined lime, slaked lime, and/or various cements, and so forth.

Anhydrous gypsum or gypsum dihydrate is ordinarily used as the gypsum.

Aluminum metal powder is typically used as the foaming agent.

Other materials may be incorporated in order to provide other properties.

The lightweight cellular concrete generally assumes a state in which high-crystallinity tobermorite (5CaO.6SiO₂.5H₂O), which is produced by reaction between the siliceous ingredient and calcareous ingredient during autoclave curing, surrounds the circumference of the silica stone.

The volumetric fraction of voids in the lightweight cellular concrete is generally about 80%. Generally, the density is 450 to 550 kg/m³; the compressive strength is 4 to 6 N/mm²; and the flexural strength is in the range of 1 to 1.5 N/mm². However, this may also be ultralightweight cellular concrete having a lower density of less than 450 kg/m³ to 200 kg/m³ (inclusive).

As a general matter, the lightweight cellular concrete panel for construction applications is roughly classified into thick panel having a thickness of at least 75 mm and thin panel having a thickness of at least 35 mm but less than 75 mm; however, sizes different from these may also be employed.

The water-based emulsion of the non-film-forming amino-modified organopolysiloxane that is used in the present invention to treat the surface of the lightweight cellular concrete panel does not form a film as its water fraction evaporates, and the cited amino-modified organopolysiloxane does not form a film when the emulsion is applied on the surface of the lightweight cellular concrete panel, allowed to infiltrate, and dried and thus is of a type that does not form a cured film or a solidified film.

This non-film-forming amino-modified organopolysiloxane preferably has a straight-chain molecular structure, but may be branched when it has a large degree of polymerization.

Viewed from the standpoints of the infiltrability or permeability into the lightweight cellular concrete, the effect of the water-repellent treatment, and bonding to the water-repellent treated surface of an acrylic-type waterborne sealant, a mortar-based repair agent, or a water-based synthetic resin paint, the non-film-forming amino-modified organopolysiloxane under consideration—and particularly the non-film-forming amino-modified diorganopolysiloxane—preferably is a fluid at ambient temperature, preferably has an amine equivalent weight of 500 to 100,000 gram/mol, and preferably has a viscosity at 25° C. of 50 to 1,000,000 mPa·s. More preferably, the amine equivalent weight is 500 to 50,000 gram/mol and the viscosity at 25° C. is 100 to 100,000 mPa·s. The viscosity at 25° C. is even more preferably 200 to 10,000 mPa·s.

The non-film-forming amino-modified organopolysiloxane is preferably a non-film-forming amino-modified organopolysiloxane yielded by the replacement of a portion of the methyl groups in a methylpolysiloxane with aminoalkyl or N-(aminoalkyl)aminoalkyl group. The non-film-forming amino-modified diorganopolysiloxane is preferably a non-film-forming amino-modified diorganopolysiloxane yielded by substituting aminoalkyl or N-(aminoalkyl)aminoalkyl group for a portion of the methyl groups in a dimethylpolysiloxane in which only methyl group is bonded to the terminal silicon atoms or in a dimethylpolysiloxane in which methyl and hydroxyl groups are bonded to the terminal silicon atoms. Such a non-film-forming amino-modified diorganopolysiloxane can be exemplified by a non-film-forming amino-modified diorganopolysiloxane yielded by substituting aminoalkyl or N-(aminoalkyl)aminoalkyl group for a portion of the methyl groups—particularly for a portion of the methyl groups in side chain position or terminal position or both positions—in a dimethylpolysiloxane chain-stopped at both terminals by trimethylsiloxy groups and by a non-film-forming amino-modified diorganopolysiloxane yielded by substituting aminoalkyl or N-(aminoalkyl)aminoalkyl group for a portion of the methyl groups—particularly for a portion of the methyl groups in side chain position or terminal position or both positions—in a dimethylpolysiloxane chain-stopped at both terminals by dimethyl(hydroxy)siloxy groups. While it is sufficient for at least one aminoalkyl group or N-(aminoalkyl)aminoalkyl group to be present in each molecule, the number sufficient to provide an amine equivalent weight of 500 to 100,000 gram/mol is preferable.

The aminoalkyl and N-(aminoalkyl)aminoalkyl groups can be exemplified by

### —CH₂CH₂NH₂,

### —CH₂CH₂CH₂NH₂,

### —CH₂CH₂CH₂CH₂NH₂,

### —CH₂CH(CH₃)CH₂NH₂,

### —CH₂CH₂CH₂NHCH₃,

### —CH₂CH₂CH₂(NHCH₂CH₂)NH₂,

### —CH₂CH₂CH₂(NHCH₂CH₂)NHCH₃, and

### —CH₂CH(CH₃)CH₂(NHCH₂CH₂)NH₂.

Preferred thereamong are —CH₂CH₂CH₂NH₂ (3-aminopropyl group) and —CH₂CH₂CH₂(NHCH₂CH₂)NH₂ (N(2-aminoethyl)-3-aminopropyl group).

The non-film-forming amino-modified diorganopolysiloxane under consideration can be exemplified by the diorganopolysiloxanes given by the average structural formulas provided below. In these formulas, Me denotes methyl group; B denotes aminoalkyl or N-(aminoalkyl)aminoalkyl group; m and n are numbers greater than or equal to 1; and m+n is a number that provides a viscosity at 25° C. of 50 to 1,000,000 mPa·s for the non-film-forming amino-modified diorganopolysiloxane.

### Me₃SiO(Me₂SiO)ₘ(MeBSiO)ₙSiMe₃

### HOMe₂SiO(Me₂SiO)ₘ(MeBSiO)ₙSiMe₂OH

### BMe₂SiO(Me₂SiO)ₘSiMe₂B

### BMe₂SiO(Me₂SiO)ₘ(MeBSiO)ₙSiMe₂B

### B(HO)MeSiO(Me₂SiO)ₘ(MeBSiO)ₙSiMe(OH)B

### B(HO)MeSiO(Me₂SiO)ₘ(MeBSiO)ₙSiMe₂B

Two or more of the aforementioned non-film-forming amino-modified diorganopolysiloxanes may be used in combination.

The water-based emulsion of the non-film-forming amino-modified organopolysiloxane that is used for the water repellency treatment in the present invention may be an oil-in-water emulsion or a water-in-oil emulsion, and an oil-in-water emulsion is preferred. However, it may not be an emulsion that undergoes curing or solidification upon removal of the water fraction to form a waterproof film. Viewed from the perspective of storage stability, the average particle size of the emulsion particles is preferably 10 to 1000 nm. This average particle size is the volume-average particle size in the volumetric particle size distribution measured on the emulsion particles by a laser scattering-type submicron particle analyzer (model COULTER N4 from Coulter Electronics, Inc.).

The water-based emulsion of the non-film-forming amino-modified organopolysiloxane may be produced by the emulsification of a non-crosslinking amino-modified organopolysiloxane in water (an emulsification type) or may be produced by an emulsion polymerization procedure (an emulsion polymerization type). It may also be produced by other methods of production.

The undiluted water-based emulsion of the non-film-forming amino-modified organopolysiloxane is a fluid at ambient temperature, and there are no particular limitations on its composition as long as a good storage stability is present. The undiluted water-based emulsion of a non-film-forming amino-modified organopolysiloxane generally comprises (A) 100 parts by weight of a non-film-forming amino-modified organopolysiloxane, (B) 1 to 20 parts by weight of an emulsifying agent, and (C) 50 to 300 parts by weight of water. 2 to 15 parts by weight are preferred for the emulsifying agent (B) and 100 to 200 parts by weight are preferred for the water (C). A water-based emulsion diluted with water 5-fold to 50-fold is preferred for executing the water-repellent treatment on the lightweight cellular concrete panel surface.

The emulsifying agent (B) is the component that brings about a stable emulsification of component (A) in the water and can be exemplified by nonionic surfactants, cationic surfactants, or amphoteric surfactants with excellent emulsifying capability, and their mixtures.

The nonionic surfactant can be exemplified by polyoxyethylene alkyl ethers and polyoxyethylene-polyoxypropylene alkyl ethers; polyoxyethylene alkylphenyl ethers; polyethylene glycol/higher aliphatic acid esters; polyoxyethylene glycerol/higher aliphatic acid esters; and polyglycerol/higher fatty acid esters.

The cationic surfactant can be exemplified by quaternary ammonium salt-type surfactants such as alkyltrimethylammonium salts and dialkyldimethylammonium salts.

The following, for example, may be incorporated on an optional basis in the water-based emulsion of the non-film-forming amino-modified organopolysiloxane insofar as the objects of the present invention are not impaired: thickeners (for example, water-soluble polymers), preservatives, penetrants, static inhibitors, dyes, and so forth.

The emulsification-type water-based emulsion can be produced by adding component (B) to the aforementioned component (A) and emulsifying this in water using an emulsifying device such as a homomixer, homogenizer, colloid mill, combination-mixer, and so forth. The emulsion polymerization-type water-based emulsion can be prepared by carrying out emulsion polymerization in water between a cyclic diorganopolysiloxane and an aminoalkyl(alkyl)dialkoxysilane.

All or a portion of the amino groups in the non-film-forming amino-modified organopolysiloxane—and particularly the non-film-forming amino-modified diorganopolysiloxane—in the water-based emulsion may be neutralized with an organic acid (for example, acetic acid) or a mineral acid (for example, hydrochloric acid), and the neutralization of a portion is preferred, that is, partial neutralization is preferred. Partial neutralization provides an excellent storage stability for the water-based emulsion itself. In addition, once the water-based emulsion has been coated on the lightweight cellular concrete panel, partial neutralization endows the water-based emulsion with resistance to breakage and thereby facilitates infiltration into the interior in the water-based emulsion state and as a consequence provides an enhanced effect from the water-repellent treatment.

The lightweight cellular concrete panel of the present invention, that is, lightweight cellular concrete panel having on its surface a water-repellent treatment layer provided by the water-based emulsion of the non-film-forming amino-modified organopolysiloxane, can be produced simply by coating or applying the water-based emulsion of the non-film-forming amino-modified organopolysiloxane on the surface—preferably on the entire surface—of a water-containing lightweight cellular concrete panel immediately after production or after standing for several days indoors, and then drying the coated or applied emulsion. A continuous application method, i.e., a method in which the lightweight cellular concrete panel is placed on a roller conveyor and passed through a stationary spray coating station, is well suited for effecting a water-repellent treatment on a variety of lightweight cellular concrete panel types having panel lengths from 1 to 6 m.

The quantity of application of the water-based emulsion of the non-film-forming amino-modified organopolysiloxane to the surface of the water-containing lightweight cellular concrete panel is preferably 0.6 to 12.0 g/m² as effective component when the plan is to subject the water-repellent treated lightweight cellular concrete panel to short-term outdoor storage, i.e., for two to three months. When the plan is to subject the water-repellent treated lightweight cellular concrete panel to outdoor storage for longer than two to three months, application at more than 12.0 g/m² as effective component is preferred and 12.0 (not including 12.0) to 24.0 g/m² as effective component is preferred.

When the emulsion is coated on the surface of a water-containing lightweight cellular concrete panel, the emulsion proceeds to infiltrate or permeate into the interior of the panel. The emulsion typically infiltrates to a depth of 1 to 2 mm from the surface. A lower viscosity for the emulsion and a larger quantity of emulsion application of course result in a deeper infiltration distance. A larger quantity of application is preferred in the case of long-term outdoor storage.

The following behavior is exhibited by the water-containing lightweight cellular concrete panel having on its surface a water-repellent treatment layer obtained in the described manner from the water-based emulsion of the non-film-forming amino-modified organopolysiloxane, even in the case of storage as such outdoors: the panel's surface is almost completely unwetted by rain or snow and does not undergo discoloration, and the water fraction initially present in the panel in large amounts gradually declines. The water content goes to less than about 10 weight % after about two weeks for 35 mm-thick panel and after one to two months for panel having a thickness of 100 mm or more and an enhanced thermal insulation performance is obtained in application as an outer wall material, floor material, roofing material, and so forth, in buildings.

### Examples

Examples of the present invention and comparative examples are described below. The following properties were evaluated for exemplary water-based emulsions of non-film-forming amino-modified dimethylpolysiloxanes (Examples 1 and 2), comparative water-based emulsions of film-forming amino-modified dimethylpolysiloxanes (Comparative Example 1, Comparative Example 2), a water-based emulsion of a non-film-forming epoxy-modified dimethylpolysiloxane (Comparative Example 3), and a water-based emulsion of an alkyltrialkoxysilane/siloxane mixture (Comparative Example 4): the film-forming behavior of the emulsion as prepared, the film-forming behavior of the emulsion diluted with water, the capacity to prevent water absorption for the panel obtained by carrying out the water-repellent treatment by spraying the surface of the water-containing lightweight cellular concrete panel immediately after the panel's production, the drying behavior (extent of the reduction in the moisture content) when a water-repellent treated panel was allowed to stand indoors (the water-repellent treatment was carried out by spraying the surface of the water-containing lightweight cellular concrete panel immediately after the panel's production), and bonding of a water-based acrylic sealant (including a primer) to the water-repellent treated surface produced by spraying the surface of the water-containing lightweight cellular concrete panel immediately after the panel's production.

[Water-Based Emulsions]

Table 1 reports the designations, type, properties, and characteristics of the water-based organopolysiloxane emulsions employed for the water-repellent treatments, while Table 2 reports the type, properties, and characteristics of the organopolysiloxanes contained in these emulsions. The % in the tables is weight %.

TABLE 1
The water-based emulsions

| | | | Comparative | Comparative | Comparative | Comparative | Comparative |
|---|---|---|---|---|---|---|---|
| classification | Example 1 | Example 2 | Example 1 | Example 2 | Example 3 | Example 4 | Example 5 |
| designation | BX22-591 | BX22-593 | BC22-971 | BC22-972 | BC22-592 | BC22-734 | uncoated |
| type | O/W | O/W | O/W | O/W | O/W | O/W | — |
| appearance | milky white | grey | milky white | milky white | milky white | milky white | — |
| | liquid | liquid | liquid | liquid | liquid | liquid | |
| pH | 5.0 | 6.2 | 9.0 | 5.0 | 6.2 | 8.5 | — |
| average particle size (nm) | 210 | 70 | 100 | 220 | 200 | 250 | — |
| siloxane content (%) | 30 | 15 | 40 | 30 | 30 | 24 | — |
| content of emulsifying agent | 3.0 | 2.9 | 5.5 | 2.7 | 6.0 | 0.5 | |
| nonvolatile fraction (%) | 31.7 | 17.3 | 41.0 | 32.0 | 35.9 | 18.8 | — |

Notes:
The average particle size is the volume-average particle size in the volumetric particle size distribution measured on the emulsion particles by a laser scattering-type submicron particle analyzer (model COULTER N4 from Coulter Electronics, Inc.).
The emulsifying agent is a surfactant-type emulsifying agent.

TABLE 2
The organopolysiloxanes

| | | | Comparative | Comparative | Comparative | Comparative | Comparative |
|---|---|---|---|---|---|---|---|
| classification | Example 1 | Example 2 | Example 1 | Example 2 | Example 3 | Example 4 | Example 5 |
| designation | BX22-591 | BX22-593 | BC22-971 | BC22-972 | BC22-592 | BC22-734 | uncoated |
| type | non-film- | non-film- | film- | film- | non-film- | non-film- | — |
| | forming | forming | forming | forming | forming | forming | |
| modification | amino- | amino- | amino- | amino- | epoxy- | no | — |
| | modified | modified | modified | modified | modified | modification | |
| amine equivalent | 7800 | 1800 | 4400 | 7800 | — | — | — |
| weight | | | | | | | |
| viscosity (mPa · s) | 1400 | 1200 | could not | could not | 6000 | 318 | — |
| | | | be measured | be measured | | | |
| partial neutralization | yes | yes | yes | yes | — | — | — |

With reference to Table 2, BX22-591 refers to a dimethylpolysiloxane that has methyl and hydroxyl groups bonded to both terminal silicon atoms and that has a portion of its methyl groups replaced by —CH₂CH₂CH₂(NHCH₂CH₂)NH₂; BX22-593 refers to a dimethylpolysiloxane that has trimethylsiloxy and dimethyl(hydroxy)siloxy groups at the terminals and that has a portion of its methyl groups replaced by —CH₂CH₂CH₂(NHCH₂CH₂)NH₂; BC22-971 and BC22-972 refer to a partially crosslinked methylpolysiloxane that has a portion of its methyl groups replaced by —CH₂CH₂CH₂(NHCH₉CH₂)NH₂; and BC22-592 refers to a methyl-terminated dimethylpolysiloxane that has a portion of its side-chain methyl groups replaced by (3,4-epoxycyclohexyl)ethyl group.

The unit for the amine equivalent weight is gram/mol. Partial neutralization was carried out with acetic acid. The viscosity of the organopolysiloxane each for BX22-591, BX22-593, and BC22-592 was determined by measurement on the actual organopolysiloxane provided to the emulsification process; the measurement was performed with a rotary viscometer at 25° C. The viscosity of the organopolysiloxane for BC22-734 was determined as follows: acetone was added to the water-based emulsion to break the emulsion; the water was evaporated off; and the residue was measured using a rotary viscometer at 25° C. In the case of BC22-971 and BC22-972, a film-form material was obtained when the water was evaporated off after the addition of acetone to break the emulsion and the viscosity could not be measured as a consequence.

[Film-Forming Behavior]

Each water-based emulsion or its dilution with water (concentration=1.5 weight % as effective component) was placed in an aluminum dish with a volume of 1 mL and was dried off in a laboratory room by standing at quiescence for 1 day. The presence/absence of film formation by the dried material was visually evaluated as follows: a score of +was rendered when the dried material was a liquid and a score of × was rendered when the dried material was filmic or rubbery and formed a film.

[Capacity to Prevent Water Absorption]

Each water-based emulsion was diluted with water to give a concentration of 1.5 weight % as the effective component and this dilution was spray coated so as to give a quantity of application of 5 g/m² as the effective component on the smooth surface and foam surface (surface planed down with an electric planer) of a 250 mm×606 mm×35 mm board (lightweight cellular concrete panel immediately after production, water content about 40 weight %, density=500 kg/m³). The coated board was held in a laboratory room for three days, after which 0.5 mL water was dripped onto the smooth surface and onto the foam surface. The site where the water was dripped was covered with a 20 mL beaker in order to prevent evaporation. The status of the remaining dripped water was observed one hour after its application.

This same evaluation was carried out on board coated in the same manner with the water-based emulsion, but in this case the evaluation was carried out after the board had been exposed outdoors for two months.

The evaluation was scored as follows: a score of + was assigned when at least half of the water drop remained; a score of Δ was assigned when the water drop remained, but less than half remained; and a score of × was assigned when the water drop did not remain.

[Bonding Strength of a Water-Based Acrylic-Type Sealant]

Each water-based emulsion was diluted with water to give a concentration of 1.5 weight % as the effective component and this diluted emulsion was spray coated so as to give a quantity of application of 5 g/m² as the effective component on the foam surface (surface planed down with an electric planer) of a 250 mm×606 mm×35 mm board (lightweight cellular concrete panel immediately after production, water content about 40 weight %, density=500 kg/m³). The coated board was held in a laboratory room for 3 days, after which an acrylic-type primer (product name: G Primer, from Nippon NSC Ltd.) was applied on the coated surface.

After half a day, a water-based acrylic-type sealant (product name: Bell Ace P4000K, from Nippon NSC Ltd.) was cast onto the primer-coated surface so as to form a bead with a width of 7 mm and a length of 200 mm. After curing by ageing for two months in a laboratory room, incisions were introduced with a cutter on a pitch length of 25 mm. The bonding strength or adhesion strength was measured (n=8) by pulling the cured sealant using a gripper with a pull width of 21 mm and a push-pull gauge (100 N maximum). Evaluation: considered relative to the absence of the coating (strength ratio 100), a score of + was assigned when the strength ratio was at least 95 and a score of × was assigned when the strength ratio was less than 95.

[Drying Behavior]

Each water-based emulsion was diluted with water to give a concentration of 1.5 weight % as the effective component and this dilution was spray coated so as to give a quantity of application of 5 g/m² as the effective component on the entire surface of a 250 mm×606 mm×35 mm board (lightweight cellular concrete panel immediately after production, water content about 40 weight %, density=500 kg/m³). The board was then placed in a laboratory room at 25±5° C. and its weight was measured after 1 day, after 2 days, after 3 days, after 6 days, after 10 days, after 15 days, after 20 days, and after 25 days, in each case timed from immediately after the board's production. The numerical values in Table 3 report the water content (weight %).

TABLE 3
Water content

| | pre- | post- | 1 | 2 | 3 | 6 | 10 | 15 | 20 | 25 |
|---|---|---|---|---|---|---|---|---|---|---|
| designation | coating | costing | day | days | days | days | days | days | days | days |
| BX22-591 | 44.8 | 49.2 | 40.5 | 33.2 | 28.6 | 19.4 | 13.2 | 8.9 | 5.7 | 4.9 |
| BX22-593 | 42.7 | 48.7 | 38.7 | 32.2 | 27.2 | 18.8 | 12.9 | 8.5 | 5.2 | 4.4 |
| BC22-971 | 42.2 | 47.5 | 38.0 | 32.2 | 27.6 | 19.8 | 13.9 | 9.7 | 6.1 | 5.3 |
| BC22-972 | 43.4 | 48.7 | 37.6 | 31.3 | 26.1 | 17.3 | 11.3 | 7.2 | 4.3 | 3.7 |
| BC22-592 | 42.2 | 47.3 | 38.2 | 32.3 | 27.4 | 19.0 | 13.1 | 8.6 | 5.4 | 4.6 |
| BC22-734 | 41.9 | 46.6 | 38.1 | 31.8 | 27.7 | 19.4 | 13.7 | 9.4 | 6.1 | 5.3 |
| uncoated | 45.1 | 45.1 | 35.9 | 30.1 | 25.3 | 16.7 | 10.9 | 7.2 | 4.3 | 3.7 |

Evaluation: a score of + was assigned when the water content after 15 days was less than 10 weight %, while a score of × was assigned when the water content after 15 days was 10 weight % or more.

[Overall Evaluation]

An overall evaluation was made on the basis of all the properties that were evaluated. Overall evaluation: an evaluation of + was made when no evaluated property received a score of ×, while an evaluation of × was made when one or more evaluated properties received a score of ×.

The results of each evaluation and the overall evaluation are reported in Table 4.

TABLE 4
Evaluation results and overall evaluation

| | | | | | Comparative | Comparative | Comparative | Comparative | Comparative |
|---|---|---|---|---|---|---|---|---|---|
| example | | | Example 1 | Example 2 | Example 1 | Example 2 | Example 3 | Example 4 | Example 5 |
| designation | | | BX22-591 | BX22-593 | BC22-971 | BC22-972 | BC22-592 | BC22-734 | uncoated |
| film-forming | original emulsion | | +liquid | +liquid | ×filmic | ×filmic | +liquid | +liquid | — |
| behavior | dilution with water | | +liquid | +liquid | ×rubbery | ×rubbery | +liquid | +liquid | — |
| capacity to | smooth | 3 days | + | + | + | + | Δ | + | × |
| prevent | surface | indoors | | | | | | | |
| water | | 2 months | + | + | + | + | × | + | × |
| absorption | | outdoors | | | | | | | |
| | foam | 3 days | + | + | + | + | × | + | × |
| | surface | indoors | | | | | | | |
| | | 2 months | + | + | + | + | × | + | × |
| | | outdoors | | | | | | | |

| | | | | | | | | |
|---|---|---|---|---|---|---|---|---|
| sealant | average bonding | 0.36 | 0.30 | 0.32 | 0.30 | 0.35 | 0.24 | 0.31 |
| bondability | strength (N/mm²) | | | | | | | |
| | strength ratio | +116 | +97 | +103 | +97 | +113 | ×77 | 100 |

| | | | | | | | |
|---|---|---|---|---|---|---|---|
| drying behavior (weight %) | 8.9 | +8.5 | +9.7 | +7.2 | +7.1 | +9.4 | +7.2 |
| overall evaluation | + | + | × | × | × | × | — |

[Drying Behavior]

In the case of the water-based emulsions of the non-film-forming amino-modified dimethylpolysiloxanes (Examples 1 and 2), the water-based emulsion of the non-film-forming epoxy-modified dimethylpolysiloxane (Comparative Example 3), and the water-based emulsion of the alkyltrialkoxysilane/siloxane mixture (Comparative Example 4), the dried material from the original emulsion and the dried material from the emulsion diluted with water were both liquids and film formation did not occur. Based on the inventors' experience there is then no risk that clogging of the nozzle or conduits in the spray coating equipment will be induced.

In contrast, the water-based emulsions of the film-forming amino-modified methylpolysiloxanes (Comparative Examples 1 and 2) exhibited filmic or rubbery film formation for both the dried material from the original emulsion and the dried material from the emulsion diluted with water. Based on the inventors' experience, during on-site coating operations this can result in clogging of the nozzle and conduits of spray coating equipment or can result in the production of a waterproof film on the roller surface during continuous roller coating operations, rendering same unusable.

[Capacity to Prevent Water Absorption]

The water-based emulsions of the non-film-forming amino-modified dimethylpolysiloxanes (Examples 1 and 2) exhibit an excellent capacity to prevent water absorption and thus an excellent water repellency. The uncoated state (Comparative Example 5) and the water-based emulsion of the non-film-forming epoxy-modified dimethylpolysiloxane (Comparative Example 3) both exhibit little capacity to prevent water absorption and thus little water repellency.

[Bonding of Water-Based Acrylic-Type Sealant]

A normal bondability to the water-repellent treated surface occurs in the case of the water-based emulsions of the non-film-forming amino-modified dimethylpolysiloxanes (Examples 1 and 2). A meager bondability to the water-repellent treated surface occurs in the case of the water-based emulsion of the alkyltrialkoxysilane/siloxane mixture (Comparative Example 4).

[Drying Behavior]

As may be understood from Table 3, the course of the decline in water content for the water-based emulsions of the non-film-forming amino-modified dimethylpolysiloxanes (Examples 1 and 2) was the same as that for the absence of coating (Comparative Example 5) and the water content 15 days after application was less than 10 weight % and thus no difference was seen.

[Overall Evaluation]

The water-based emulsions of the non-film-forming amino-modified dimethylpolysiloxanes (Examples 1 and 2) gave satisfactory results on all of the evaluations.

### INDUSTRIAL APPLICABILITY

The water-repellent lightweight cellular concrete panel of the present invention and the inventive water-repellent lightweight cellular concrete panel for short-term storage are useful, for example, as an outer wall material, floor material, roofing material, and so forth, in buildings.

The water-based organopolysiloxane emulsion of the present invention for effecting a water-repellent treatment is useful for carrying out a water-repellent treatment on lightweight cellular concrete panels and lightweight cellular concrete panels for short-term storage.

1. A water-repellent lightweight cellular concrete panel comprising a lightweight cellular concrete panel having on its surface a water-repellent treatment layer formed from a water-based emulsion of a non-film-forming amino-modified organopolysiloxane.

2. A method of producing a lightweight cellular concrete panel having a water-repellent treatment layer on its surface, said method comprising:
applying, by a spray method or a roller coating method, a water-based emulsion of a non-film-forming amino-modified organopolysiloxane to the surface of the lightweight cellular concrete panel; and
drying the emulsion.

3. A water-repellent lightweight cellular concrete panel for short-term storage, comprising a water-containing lightweight cellular concrete panel that has siliceous material and calcareous material as its base ingredients and that has been produced by causing cells to be present therein, thereafter semi-curing, and further curing with steam at high temperature and high pressure, and a water-repellent treatment layer formed on the surface of the water-containing lightweight cellular concrete panel by the attachment to this surface, at 0.6 to 12.0 g/m² as effective component, of a water-based emulsion of a non-film-forming amino-modified organopolysiloxane.

4. A method of producing a water-repellent lightweight cellular concrete panel for short-term storage, that has a water-repellent treatment layer on its surface, said method comprising:
applying, by a spray method or a roller coating method, a water-based emulsion of a non-film-forming amino-modified organopolysiloxane at 0.6 to 12.0 g/m² as effective component to the surface of a water-containing lightweight cellular concrete panel that has siliceous material and calcareous material as its base ingredients and that has been produced by causing cells to be present therein, thereafter semi-curing, and further curing with steam at high temperature and high pressure; and
drying the applied emulsion.

5. A water-based organopolysiloxane emulsion for effecting a water-repellent treatment on the surface of a lightweight cellular concrete panel, characterized in that the emulsion is an O/W emulsion, the average particle size of the emulsion particles is 10 to 1000 nm, and the organopolysiloxane is a non-film-forming amino-modified organopolysiloxane and has an amine equivalent weight of 500 to 100,000 gram/mol and a viscosity at 25° C. of 50 to 1,000,000 mPa·s.

6. The water-based organopolysiloxane emulsion according to claim 5 for effecting a water-repellent treatment on the surface of a lightweight cellular concrete panel, characterized in that the non-film-forming amino-modified organopolysiloxane is a non-film-forming amino-modified diorganopolysiloxane.

7. The water-based organopolysiloxane emulsion according to claim 6 for effecting a water-repellent treatment on the surface of a lightweight cellular concrete panel, characterized in that the non-film-forming amino-modified diorganopolysiloxane is a dimethylpolysiloxane that has only methyl groups bonded to the terminal silicon atoms or that has methyl and hydroxyl groups bonded to the terminal silicon atoms and that has a portion of its methyl groups replaced by aminoalkyl or N-(aminoalkyl)aminoalkyl group.
